(19) United States
(12) Patent Application Publication
(10) Pub. No.: US 2018/0089461 A1
(43) Pub. Date: Mar. 29, 2018

(54) SECURE PROCESSING SYSTEM THAT PROTECTS PERSONAL IDENTIFIABLE INFORMATION (PII)

(71) Applicant: GLOBAL CORNERS LLC, Upper Marlboro, MD (US)

(72) Inventors: Bobby WILLIAMS, Upper Marlboro, MD (US); Terrell BYRD, Los Angeles, CA (US)

(73) Assignee: GLOBAL CORNERS LLC, Upper Marlboro, MD (US)

(21) Appl. No.: 15/718,933

(22) Filed: Sep. 28, 2017

Related U.S. Application Data
(60) Provisional application No. 62/401,477, filed on Sep. 29, 2016.

(51) Int. Cl. G06F 21/62; G06Q 20/38; G06F 21/53

(52) U.S. Cl. CPC G06F 21/6245; G06Q 20/3829; H04L 9/08; G06Q 2220/00; G06F 21/53

(57) ABSTRACT

A secure processing system to protect personal identifiable information (PII) issued by an authorized PII entity to a user seeking to conduct a service with a service provider computing device of a service provider already registered with the secure processing system, includes: a server to receive the PII, a token key, an authorized time frame identifier for a request of service, and service provider identifier from the user, a processor to generate a secure system token, token key, authorized time frame identifier and identifier; wherein: the server sends the token to the user, and the server receiving the token, the token key and a request for service from the service provider computing device in response to a request for service which includes the token and the token key received from the service provider computing device based upon the request for service requested by the user from the service provider computing device, the processor reverse engineering the PII of the user based upon the received request for service from the service provider computing device, and the server sending the reverse engineered PII to the authorized PII entity or back to the service provider computing device to complete the request for service.

### CROSS-REFERENCE TO RELATED APPLICATIONS

This application claims the benefit of priority to U.S. Provisional Application No. 62/401,447, filed Sep. 29, 2016 in the U.S. Patent and Trademark Office.

### BACKGROUND OF THE INVENTION

### 1. Field of the Invention

In today's landscape, the collection and storage of personal identifiable information (PII) used by service providers to identify people is expanding at an alarming rate. PII may be, for example, personal information about individuals, like name, or date of birth, or financial information, such as credit card or bank account information of the individual. A service provider as set for in this document refers to any business or government entity that requires the collection and storage of PII data. It is up to each service provider to securely hold and protect PII and hope that this information is not compromised by malicious individuals, such as hackers. Individuals have no control over this process and must trust that each service provider has implemented the latest security techniques to protect their information. The loss of PII typically leads to identify theft. Identify theft is growing and costs businesses billions of dollars annually.

Today's market gives service providers and everyone involved in the processing chain the option to store PII. The drawbacks of this approach is evident as people learn through-personal experience or the news reporting that a major merchant falls victim to being hacked or when people receive a new credit card in the mail or government agencies such as OPM get hacked.

### 2. Description of the Related Art

A known market secure processing system 100 operates as shown in FIG. 1. A service provider 110, through a service provider computing device 540, acquires PII 112, which can be anything from a credit card number, a social security number, an email address, name/address or any information that can uniquely identify you from another person, and then forwards the PII 112 to a PII processor gateway 120. The PII processor gateway 120 then forwards the PII 112 to an authorized PII entity 130. The authorized PII entity 130 is the entity that issued the PII 112 to the person, or an entity that is authorized to process the PII 112. The authorized PII entity 130 can be a credit card company like MasterCard, Visa, the IRS, a bank, or in the case of social security numbers, the Social Security Administration (SSA), At each operation in the process, each party has the option to store a person's PII 112, which provides hackers with more opportunities and targets for identity theft.

### SUMMARY OF THE INVENTION

It has become critical and extremely cost effective for users to use a secure processing system, as set forth in embodiments of the present invention, when providing personal information, such as credit cards, social security card numbers, birthdates, and other personal information, which are PII, to service providers, such as merchants, government entities and other types of businesses that use PII. It would be advantageous for the secure processing system to ensure PII information only be shared between an authorized PII entity and the user when the user grants access to its PII information.

A secure processing system can be implemented with minimal modifications to the current commerce system. By using the capabilities of the secure processing system, billions of dollars can be saved by avoiding credit card fraud as well as increasing consumer confidence in the systems protecting PII.

The secure processing system, according to the embodiments of the present invention, allows users to create tokens, which are governed by time, service provider identity, and token keys. The ability of the secure processing system to restrict the validity of tokens by these parameters increases the security of the token. The authorized time can be set by the user by selecting a time frame for the validity of the token or may be automatically set by the secure processing system at the time of a request for service to an appropriate time window to allow processing of the request for service. If the token is not used within the authorized time frame, the token is no longer valid and cannot be used. An automatic selection of the time frame by the secure processing system can also be triggered at the service provider by any device, such as an NFC device, that can communicate with the service provider being waved over the service provider computing device. The secure processing system will select an appropriate time frame to allow the transaction to process. In the case of transaction systems, such as consumer services that process credit card or ATM cards, the time frame will be as small as possible to reduce the chance of the token being compromised. Within the secure processing system, a service provider identifier is determined by a user selecting a service provider that is authorized to use the token manually in a secure processing system client application, selecting a radius of where the token can be used and the secure processing system grants all service providers registered with the secure processing system within the radius the ability to use the token, or the secure processing system can use GPS at the time of request for service to automatically choose the service provider for the user. Other ways to determine the service provider identifier may also be used. The user chooses a token key that will be provided to the service provider. The token key may be a PIN, fingerprint, biometrics or any technology that allows the secure processing system to verify use of the token. The secure system client application is any mobile app, tablet app or Internet application, or any other input implementation, that is developed by the secure processing system company for use by the user to generate tokens. Once the security parameters are chosen for the token, the secure processing system allows the user to choose which PII data the token will represent. The secure processing system categorizes PII into two types, restricted and non-restricted. Restricted PII is defined as PII that can only be shared with an authorized PII entity, such as credit card numbers or social security numbers. Non-restricted PII is information that can be shared with the service provider, such as name, address, and email address. The secure processing system gives the user the capability to define which non-restricted PII will be a part of the token that can be shared with service providers. Obviously, certain service providers require more PII information from a user to conduct business than others. Therefore, the flexibility for secure processing system to allow the user to define what non-restricted PII comprises a token is an agreement between the user and the service provider.

The user then goes to the service provider to initiate a request for service. The user enters their token along with the token key into the service provider's computing device. The token and token key can be entered into the service provider computing device either manually or using, as an example, a Near Field Communication (NFC) device such as a secure processing system Client Application to wirelessly transmit the user's token and token key to the service provider's computing device. The service provider's computing device, then submits a request for service to the secure processing system with the user token, token key, service provider credentials and request for service details. The service provider credentials are supplied to the service provider when it registers with the secure processing system. The request for service details vary by service provider and can represent any information that is needed to complete a process. For example, the service details of an order at a restaurant is the cost of the goods provided to the user, whereas the service details for an HR system may be to collect a person's name, address and social security number. The secure processing system receives the request for service details and reverse engineers the token into the original PII with a process to be explained later in this document. The secure processing system never stores the PII information. Based on the type of PII that is being reverse engineered, the secure processing system will choose the appropriate action. For restricted PII, the secure processing system forwards the PII and the request for service details to the appropriate authorized PII entity. In the case of non-restricted PII, the secure processing system responds to the service provider with PII information about the token, such as name, address or birthday.

Since service provider systems never process PII and never store the PII, the secure processing system effectively reduces the number of targets for hackers. Furthermore, restricted PII can be kept between authorized entities of PII and the user to whom the PII identifies. In addition, the secure processing system increases the security of tokens because the secure processing system tokens are governed by time, authorized service provider, and an access token key which are controlled by the user. Using these user-defined parameters grants access to the process that can reverse engineer the PII from the token. In addition, the secure processing system is mobile ready for users, and there is minimal change to a service provider operation, i.e., communication with the secure processing system.

According to an embodiment of the present invention, a secure processing system to protect personal identifiable information (PII) issued by an authorized PII entity to a user seeking to conduct a service with a service provider already registered with the secure processing system, includes: a server to receive the PII, a token key, an authorized time frame identifier for a request of service, and geo-location/service provider identifier from the user, a processor to generate a secure system token based upon the received PII, token key, authorized time frame identifier and a service provider identifier; wherein: the server sends the token to the user, and the server receiving the token, the token key and a request for service from the service provider in response to a request for service which includes the token and the token key received from the service provider based upon the request for service requested by the user from the service provider, the processor reverse engineering the PII of the user based upon the received request for service from the service provider, and the server sending the reverse engineered PII to the authorized PII entity or back to the service provider to complete the request for service.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows the market before a secure processing system according to one example of the related art;

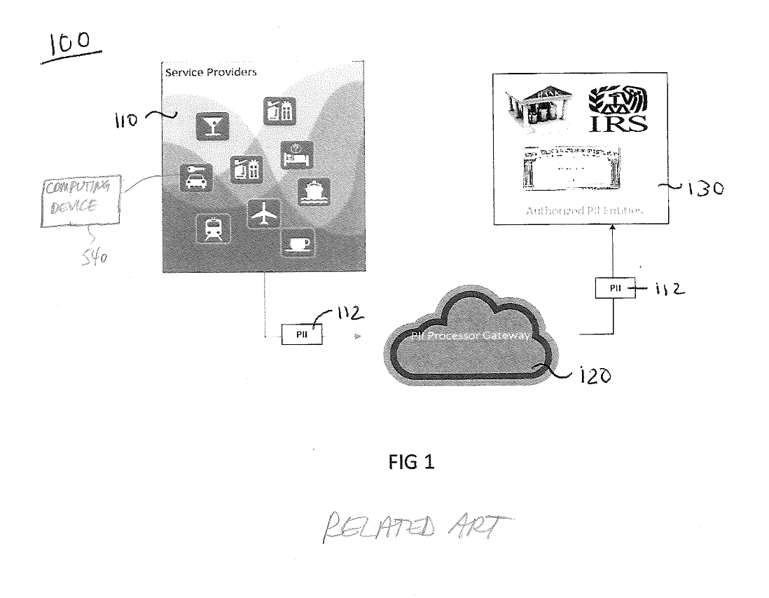

FIG. 2 shows a process for user interaction with the secure processing system according to an embodiment of the present invention;

FIG. 3 shows a market for a secure processing system process according to an embodiment;

FIG. 4 shows a secure processing system according to the embodiment shown in FIG. 2;

FIG. 5 shows process for user interaction with the service provider shown in FIG. 3;

FIG. 6 shows a process for a user that wants to create a new Secure Processing System token for a future request for service at a service provider;

FIG. 7 shows a process for the service provider to request the secure processing token be verified and reverse engineered into the original PII and forward the PII to an authorized PII entity;

FIG. 8 shows a process of a secure processing system encoder to encode a PII;

FIG. 9 shows a process of a secure processing system PII decoder for decoding the secure processing system token;

FIG. 10 shows an embodiment where unique identifier information of a common user is shared amongst service providers registered with the secured processing system;

FIG. 11 shows a process for user interaction with a secure processing system according to another embodiment of the present invention; and

FIG. 12 shows interaction between a secure processing system and a service provider computing device according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

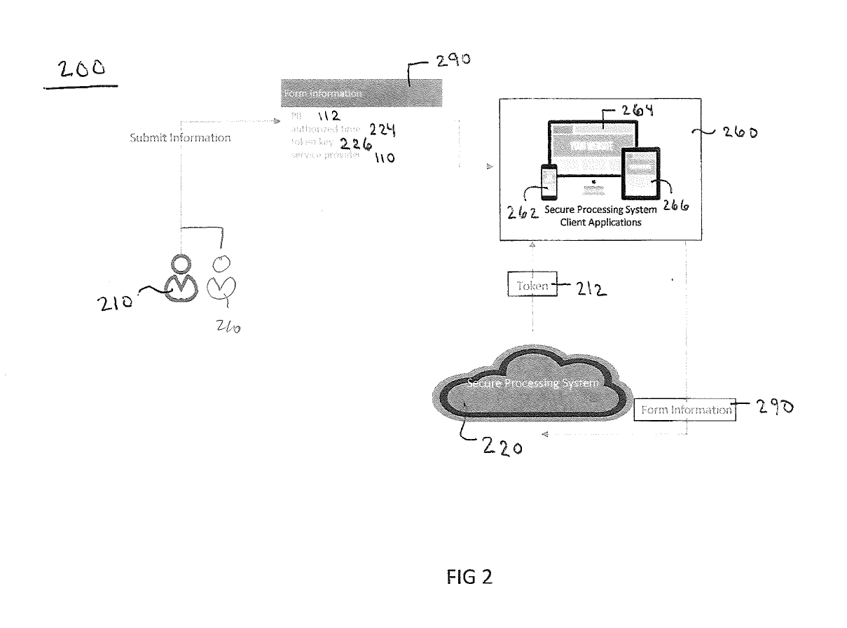

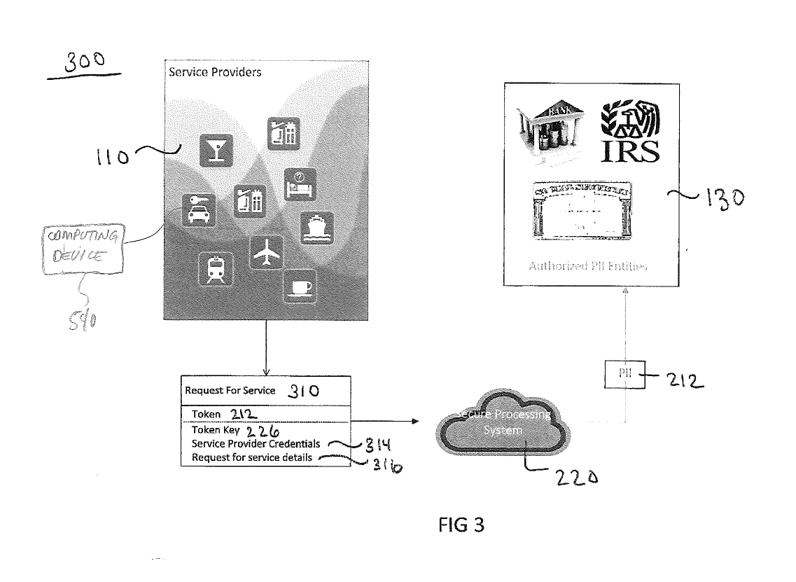

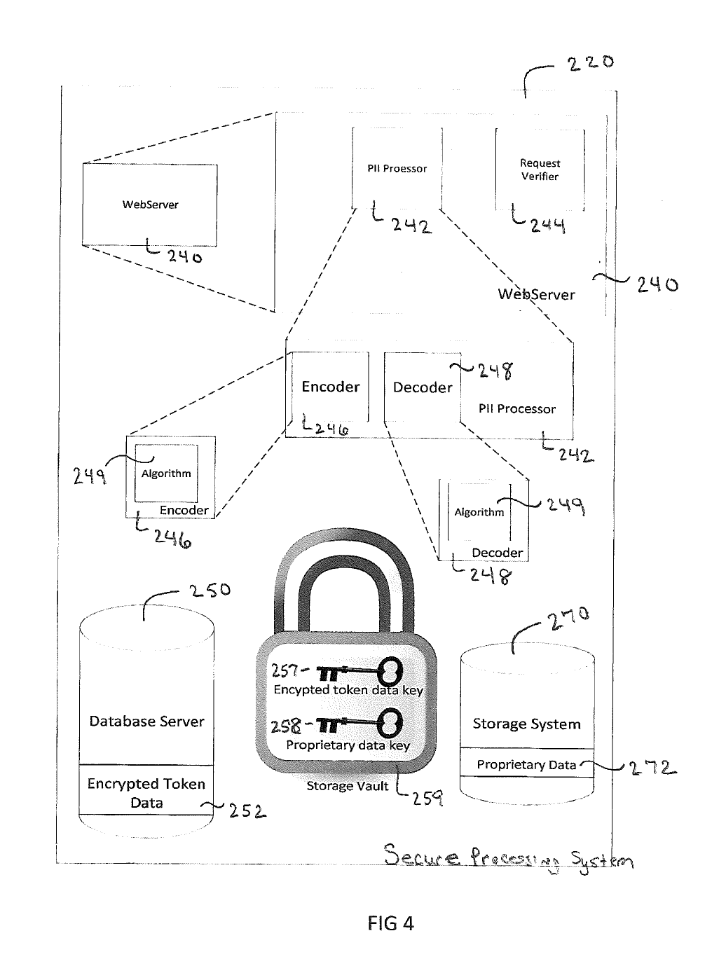

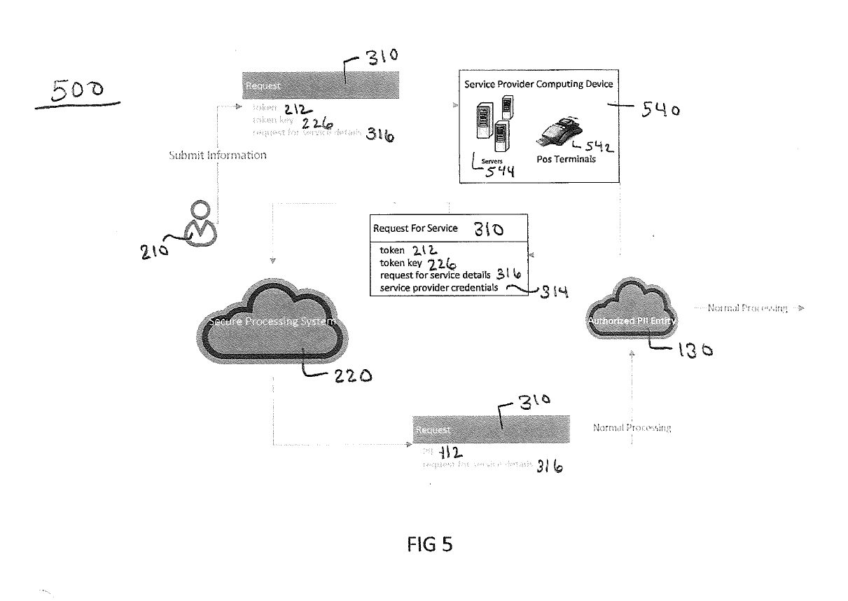

In view of the drawbacks of the related art, FIG. 2 shows a secure processing system process 200. A secure processing system 220 according to an embodiment of the present invention provides a very high level of protection of PII 112 used by service providers 110 utilizing service provider computing devices 540 (see also FIG. 5) to identify users 210 with the current secure processing system 220, users 210 do not give the service providers 110 their PII 112. Instead, a secure processing system token 212 is given. The secure processing system 220 does not store the user's PII 112 in any part of its system. The secure processing system 220 has a PII processor 242 (see FIG. 4), which may actually be multiple processors, that can reproduce the user's PII 112. The secure processing system 220 will verify a request for service from the service provider computing device 540 and reverse engineer the user's PII 112 and then forwards the request for service details 316 (see FIG. 3) along with the PII 112 on to an authorized PII entity 130. An authorized PII entity 130 does not necessarily have to be the entity that issued the PII. For example, the IRS could be an authorized entity that handles social security numbers for tax purposes but the Social Security Administration is the body that issues social security numbers. This essentially reduces the number of places that need to be protected, down to the authorized PII entities 130. This is the ideal scenario.

The authorized PII entity 130 should be the one responsible for protecting the PII 112. The secure processing system 220 is not intended for storing the PII 112, but instead, creates new tokens and gives the user the power to choose when, how, and who can use these new tokens 212. The secure processing system tokens 212 are governed by an authorized time frame 224, the authorized service provider 110, and an access token key 226, which are the parameters that are collected by the secure processing system 220 to give the user 210 control over token 212 use.

FIG. 2 shows the process 200 of the user interaction with the secure processing system 220 according to an embodiment of the present invention. A user 210 submits a request to the secure processing system 220 to create a token 212 by providing the Pit 112 along with specifying what service provider (s) 110 is/are allowed to use the token 212, the authorized time frame 224 for use of the token 212 and a token key 226 for use of the token 212. The submission of form information 290 is done by the user 210 entering the form information 290 into a secure processing system client application 260 to be used to access the secure processing system 220. The secure processing system client application 260 can be accessible through many different ways, such as through a mobile phone app 262, a website 264 such as through a computer or mobile phone, or through a tablet app 266, or any other input implementation. The secure processing system client application 260 then submits the form information 290 to the secure processing system 220. The secure processing system 220 then generates the token 212 which has the following restrictions: (1) the authorized time frame 224 to use the secure system token 212, (2) a token key 226 which must be provided for use of the secure system token 212; and (3) the service provider(s) 110 that is/are permitted to use the secure processing system token 212. The token 212 is then returned to the secure processing system client application 260 and is ready for use by the user 210 at the selected service provider(s) 110.

The authorized time frame 224 can be set by the user 210 by selecting a time frame for the validity of the token 212 or may be automatically set by the secure processing system 220 at the time of the request for service to an appropriate time window to allow processing of the request for service. If the token 212 is not used within the authorized time frame 224, the token 212 is no longer valid and cannot be used. The automatic selection of the authorized time frame 224 by the secure processing system 220 can be triggered, for example, at the service provider computing device 540 by any device, such as an NFC device (a device of the user 210), that can communicate with the service provider computing device 540, being waved over the server provider computing device 540 (see FIG. 5). The secure processing system 220 will select an appropriate time frame to allow the transaction to process. In the case of transaction systems, such as consumer services that process credit card or ATM cards, the time frame will preferably be as small as possible to reduce the chance of the token 212 being compromised.

FIG. 3 shows a secure processing system process (market) 300 according to an embodiment of the present invention. When a service provider computing device 540 begins a request for service 310 initiated by the user 210, the service provider computing device 540 collects the user token 212, the token key 226 and request for service details 316 and combines that with the service provider's credentials 314. The service provider credentials 314 are received when the service provider 110 has previously signed up for service with the secure processing system 220. The service provider computing device 540 submits the request for service 310 to the secure processing system 220. The secure processing system 220 receives the request for service 310 and reverse engineers the PII 112. The secure processing system 220 forwards the PII 112 to an authorized PII entity 130 for processing as normal.

FIG. 4 shows the secure processing system 220 according to an embodiment and includes a web server 240, the PII processor 242, a request verifier 244, an encoder 246, a decoder 248, an algorithm 249, a database server 250 (such as an RDMS or Cloud Document Management System), a storage vault 259 (such as an Amazon S3 bucket to store an encrypted token data key 257 and a proprietary data key 258), and a data storage system 270 (such as a File/RDMS/Cloud Document Management System/In Memory Cache) to store proprietary data 272 The web server 240 is comprised of main application logic which includes the PII processor 242, the request verifier 244, the encoder 246, the decoder 248, and the algorithm 249. The PII processor 242 uses the encoder 246 and decoder 248 to encode the PII 112 into a token 212 and decode a token 212 back into the PII 112. The encoder 246 and decoder 248 rely on the algorithm 249 that contains the knowledge of how to translate the PII 112 into a token 212 and vice versa. The secure processing system 220 can be accessed via a cloud or through a fixed, hard-wired and/or other type of network system. The database server 250 stores encrypted token data 252 which is used in the process of encoding a token 212 and decoding a token 212. More details of this process are given later in the specification. The encrypted token data 252 can be unlocked via the encrypted token data key 257. The data storage system 270 stores the secure processing system encrypted proprietary data 272, which is also encrypted. The proprietary data 272 is also used in the process of creating a token 212 as shown in FIG. 2 and reverse engineering a token 212 into the PII 112 as shown in FIG. 3. The proprietary data 272 can be unlocked via the proprietary data key 258. The keys 257 and 258 are stored in the storage vault 259 which can be any secure mechanism which requires a valid key to get into the storage vault 259, such as the Amazon S3 bucket or cloud services of the like.

FIG. 5 shows a process 500 for user interaction with the service provider computing device 540, wherein the user (consumer) 210 submits a request for service 310 to the service provider computing device 540 that has been authorized to use the secure processing system 220. The service provider's computing device 540 can be any computing device that has the capability to communicate with the secure processing system 220, such as servers 544 and Point of Sale (POS) terminals 542, as examples only, to submit the request for service 310. The user 210 submits the request for service 310 information which includes the token 212, the token key 226 and the request for service details 316 to the service provider computing device 540. The request for service details 316 can vary depending on the services of the service provider 110 submitting the request for service 310 through the service provider computing device 540. Examples can include purchasing groceries at a grocery store or submitting payroll to the IRS. The service provider computing device 540 appends the service provider credentials 314 to the request for service 310 information entered by the user 210 and submits the request for service 310 to the secure processing system 220. The secure processing system 220 verifies if the information in the request for service 310 matches the constraints specified by the user 210 for use of the token 212 and if validation succeeds, the secure processing system 220 reverse engineers the token 212 and converts it into the original PII 112. The secure processing system 220 then forwards the request for service 310, which is now modified to include the PII 112 and the request for service details 316, to the authorized PII entity 130.

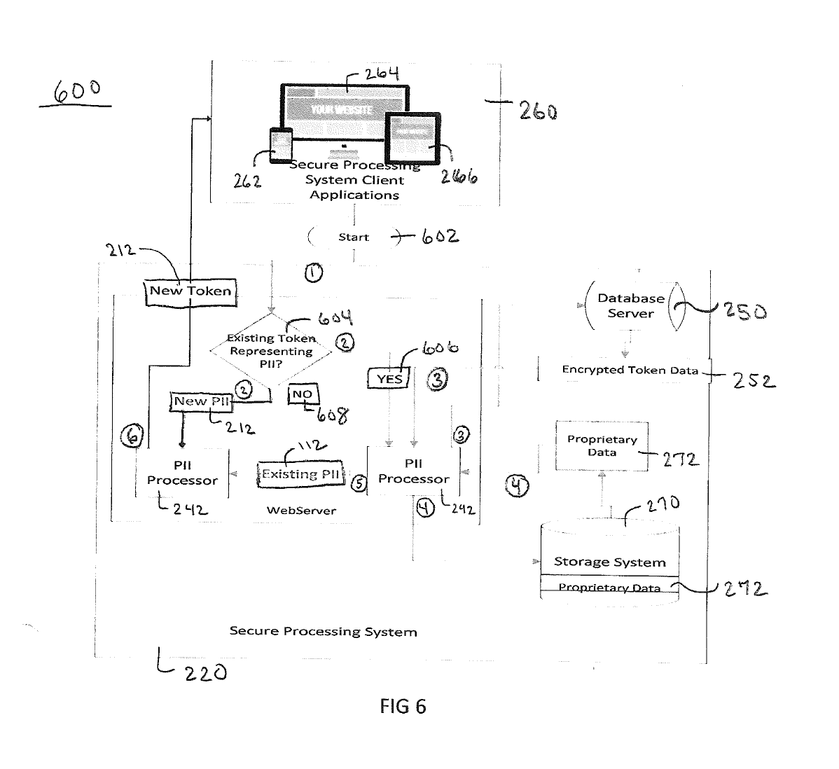

FIG. 6 shows a process 600 for requesting a secure processing system token 212 for a future request for service 310 at a service provider computing device 540. A user 210 interacts with the secure processing system client application 260 to request the creation of a new token 212. The user 210 may be requesting a new token 212 be made based off of an existing token which represents previously registered PII or the user may request a new token 212 be made for PII 112 that has not yet been registered with secure processing system 220. The secure processing system 220 provides this option to simplify the user interaction with the secure processing system 220 because the user only has to register PII 112 with the secure processing system 220 once.

The process starts at operation 602, where the secure processing system client application 260 sends a request to the secure processing system 220. At operation 604, it is determined if the user 210 wants to create a new token 212 based on an old token 212, which represents the PII 112 already registered with the secure processing system 220, or create a new token 212 for a new PII 112 that has not been registered with the secure processing system 220.

If YES, then operation 606 executes, and the secure processing system 220 will create a new secure processing system token 212 based on an existing token 212. The PII processor 242 will contact the database server 250 and ask the database server 250 to look up the existing token 212. If found, the database server 250 will return encrypted token data 252. The PII processor 242 will receive the encrypted token data 252. The PII processor 242 will also contact the data storage system 270 for proprietary data 272. The PII processor 242 will use the encrypted token data 252 and the encrypted proprietary data 272 to reverse engineer the original PII 112. The PII processor 242 will then encode the PII 112 and generate a new token 212. The new token 212 is then sent to the secure processing system client application 260.

If NO in operation 604, then the operation 608 executes, and the secure processing system 220 will create a new secure processing system token 212 for the PII 112 that has not previously been registered with the secure processing system 220. The PII processor 242 will receive the PII and then encode the PII 112. A token 212 is then sent to the secure processing system client application 260.

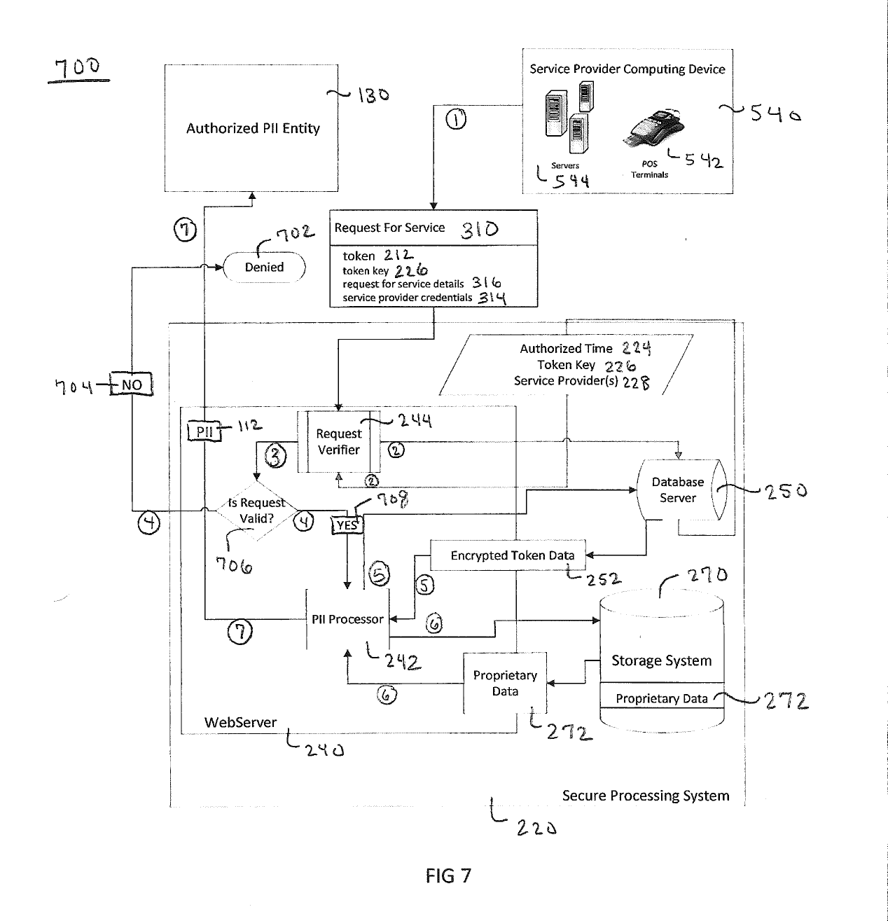

FIG. 7 shows a process 700 for the service provider computing device 540 to request the secure processing token 212 to be verified and forwarded to the authorized PII entity 130. The process starts with the service provider computing device 540 that is authorized to communicate with the secure processing system 220 gathering the token 212, token key 226 and request for service details 316 and the service provider computing device 540 appending the service provider credentials 314 to access the secure processing system 220. The service provider computing device 540 can receive this information over any network, NFC, wireless, WIFI or even manual typing. The service provider computing device 540 sends the request for service 310 to the web server 240 of the secure processing system 220. The web server 240 hands the request for service 310 to the request verifier 244 to assess whether this is a valid request to use the token 212, in operation 706. The request verifier 244 will contact the database server 250 and request the authorized time frame 224, token key 226 and service provider(s) 110 associated with the token 212. The request verifier 244 will use the information to determine if the token 212 is being used by the proper service provider computing device 540 within the authorized time 244 and also verify the token key 226. If the request verifier 244 determines the request is valid, then per operation 708, the PII processor 242 will reverse engineer the token 212 into the PII 112. The PII processor 242 contacts the database server 250 and asks for the encrypted token data 252 associated with the token 212. The PII processor 242 also contacts the storage system 270 for the proprietary data 272. The PII processor 242 decodes the token 212 and reverse engineers the token 212 into the original PII 112 by using the encrypted token data 252 and the proprietary data 272. Once the PII processor 242 finishes reverse engineering the PII 112, it then forwards the PII 112 to the PII authorized entity 130. If the request verifier 244 determines that the request is not valid, then operation 704 executes, and the request to reverse engineer the request for service 310 is denied in operation 702.

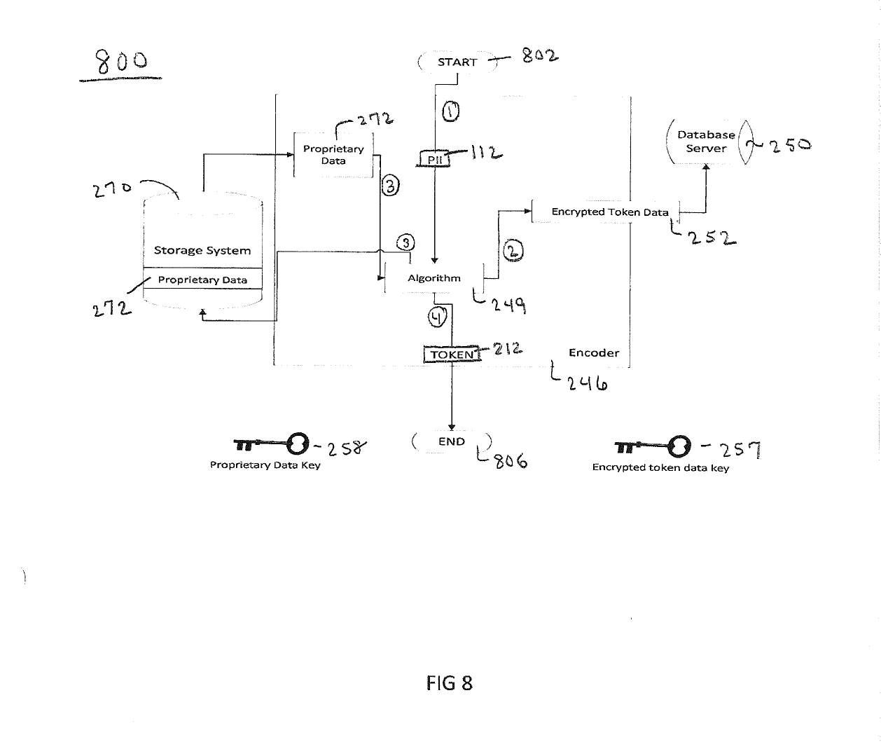

FIG. 8 shows a process 800 of the encoder 246 of the PII processor 242. When a request to produce a secure process system token 212 is received, the encoder 246 will receive the PII 112 and use an algorithm 249 and proprietary data 272 to process the PII 112. The algorithm 249 examines the PII 112, unencrypts the proprietary data 272 using the proprietary data key 258 to create a token 212. In addition, the encoding algorithm 249 encrypts some token data using the key 257. The encrypted token data 252 is then saved into the database server 250. The encoder outputs the token 212 and the operation ends at operation 806.

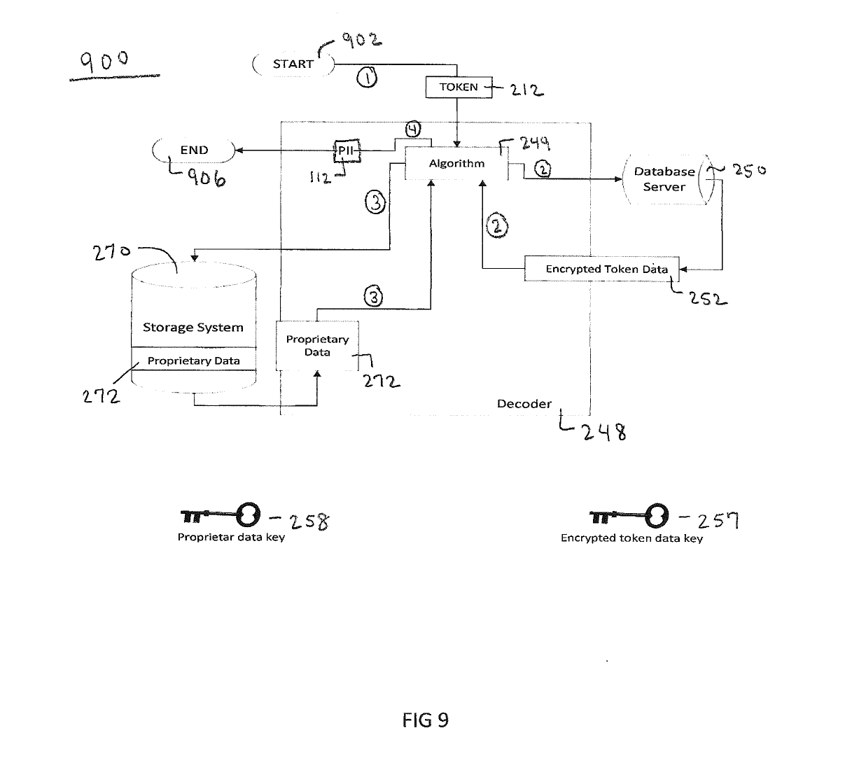

FIG. 9 shows a process 900 of the decoder 248 of the PII processor 242 for decoding the secure processing system token 212. The decoder 248 will receive the token 212 and use an (decoding) algorithm 249 to process the PII 112. The decoding algorithm 249 asks the database server 250 for the encrypted token data 252. The decoding algorithm 249 will then ask the storage server 270 to retrieve the proprietary data 272. The decoding algorithm 249 will then decrypt the token encrypted data using the encrypted token data key 257 along with decrypting the proprietary data 272 using the proprietary data key 258 and use this information along with the token 212 to reverse engineer the PII 112.

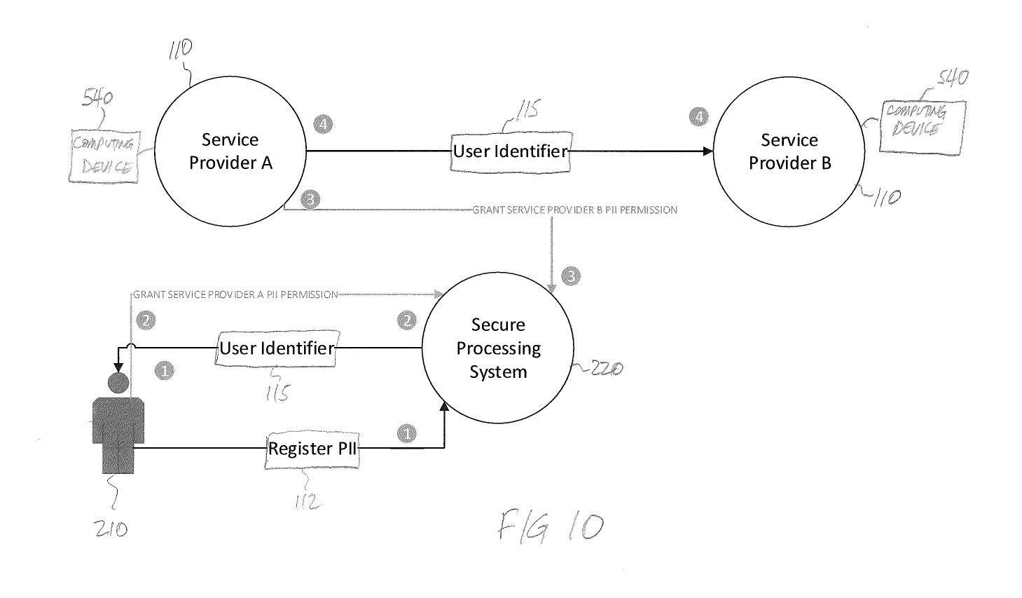

In an embodiment, the secure processing system 220 sets a unique user identifier 115 for each registered user 210. As an example, as shown in FIG. 10, a user 210 grants a service provider A 110 permission to have the secure processing system 220 decode the user's 210 PII 112. The user 210, also known as a common user, will also have to acknowledge an agreement that the service provider A may be required to share its PII 112 with another service provider B 110. When sharing user 210 PII 112, the service provider A 110 will send a request to the secure processing system 220 to grant access to service provider B 110 of the user 210 PII 110. Once registered, the service provider A 110 and the service provider B 110 can communicate using the user identifier 115 of the user 210. When either service provider A or service provider B needs to access the user 220 PII 112, a request is sent to the secure processing system 220 with the unique user identifier 115 for decoding of the user 220 PII 112.

Therefore, multiple service providers 110 can communicate with each other using the unique user identifier 115 about a common user 210 without sending the user's 210 PII 112. An example would be when a user's 210 social security number is shared between the company (employer as one service provider A 110) at which the user 210 is employed and a health insurance provider (as another such service provider B 110). Here, the employer 110 would not need to send the health insurance provider 110 the social security number. The employer 110 and the health insurance provider 110 could share the unique user identifier 115 of the user 210. When the health insurance provider 110 needs the actual social security number, a request is sent to the secure processing system 220 to reverse engineer the social security number. In this way, neither the employer (service provider A) 110 nor the health insurance provider (service provider B 110) has the user's PII 112 on its computing systems 540.

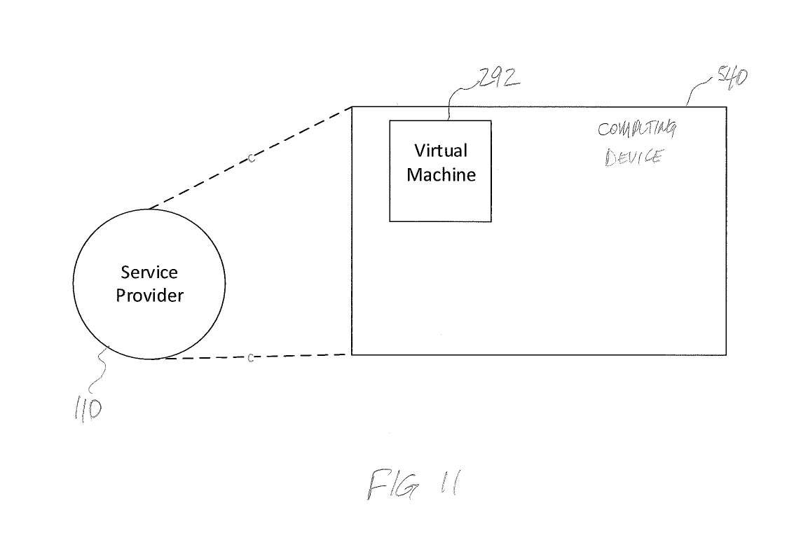

According to another embodiment, as shown in FIG. 11, each service provider 110 can be assigned a secure virtual machine 292 that is responsible for determining if the secure processing system 220 is online. The virtual machine 292 can be an emulation of a computer system, which may involve specialized hardware, software, or a combination thereof. If the secure processing system 220 is online, the request to decode the PII 112 is forwarded to the secure processing system 220. If the secure processing system 220 is offline, the virtual machine 292 will be responsible for handling the request to decode the PII 112. A virtual machine is any computer-processing unit that is able to execute the functions of the PII processor 242,

In another embodiment, the virtual machine 292 can simply replace the PII processor 242, and perform the operations of the PII processor 242.

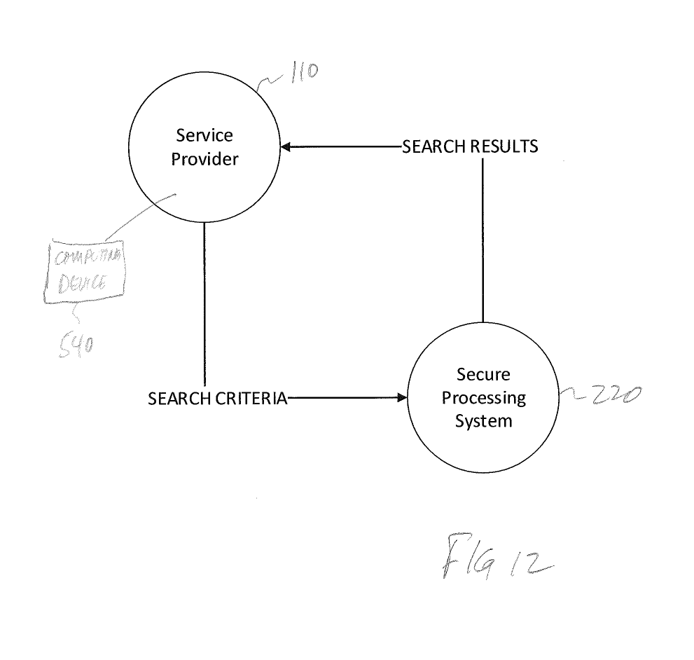

According to another embodiment, as shown in FIG. 12, a service provider computing device 540 of a service provider 110 can request one or multiple user's PII 112 information from the secure processing system 220 by sending search criteria to the secure processing system 220. If the request is valid, the secure processing system 220 will return the PII 112 information (search results) that matches the search criteria. The secure processing system 220 classifies PII 112 into two variations, restricted and non-restricted. Restricted PII will not be shared with the service provider computing device 540. The service provider computing device 540 can only verify Restricted PII 112. Verification includes submitting complete or partial PII 112 to the secure processing system 220 for a user and the secure processing system 220 returns whether or not the submitted PH 112 matches the PII 112 for the user registered with the secure processing system 220. Non-restricted PII 112 (search results) may be returned to the service provider computing device 540 if it matches the search criteria submitted by the service provider computing device 540. Non-restricted PII 112 will be returned to the service provider computing device in its complete form. Merely by way of examples, restricted PII 112 may be social security and credit card numbers, and non-restricted PII 112 information may be name, address and date of birth.

The above descriptions and figures disclose embodiments of a secure processing service which provides a complete solution to protecting PII. Other technologies in the related art subscribe to only protecting certain types of PII data. For example, Apple Pay and Google Wallet can only be used at point of sale POS terminals. A secure processing solution is all encompassing and actively involves the user in the process of protecting their personally identifiable information. The secure processing system according to embodiments of the present invention gives the user the ability to not disclose PII to service providers. In addition, the above-described secure processing system takes security to another step by providing the user the ability through the use of parameters to determine who can use the token and when and where the token can be used. These parameters provide extensive layers of security to the user. In addition, the secure processing system does not store PII information in its systems. The secure processing system uses a distributed data storage mechanism to protect PII information. So, not only are all secure processing system data sources needed to compute the PII, but also intimate knowledge about how the secure processing system functions as well as all secure processing system keys to decrypt data stored in the secure processing system. The secure processing system provides ease of use by not requiring the user to constantly re-register PII each time they want to generate a token. The secure processing system provides a register PII one-time solution and issues a token that represents the PII from which other tokens can be generated.

In typical commerce transaction systems, if your credit card data is compromised, the credit card can continue to be used until the user reports the credit card lost/stolen or the credit card company notices fraudulent activity and stops the process. The secure processing system tokens, if compromised, can only be used within an authorized time, at authorized service providers, and a token key must be given before the request for service can be processed. The user selects the authorized time frame with options as discussed in the foregoing. The user can select the service provider (s) with options, and the user provides a token key. These features add to the security of the token and place the user in full control of how their tokens can be used.

Using the secure processing system described above can eliminate the need for consumers to reveal information like credit card numbers, social security numbers and other Pit to service providers. The potential benefits of the secure processing system can be a game changer in protecting the PII of users when conducting a purchase, a transaction, or task with a third party, such as a merchant, business, or government agency.

Since the use of the secure processing system can eliminate the Pit from service provider systems, a mechanism to access certain PII information must be provided to the service provider. Service providers can still gain access to non-restricted Pit information related to a token such as name, address and date of birth. Access to such information is controlled by the user and what information they choose to reveal to the service provider. Some service providers, such as your doctor, may require more PII information than other service providers. In either case, a token created by the user will represent the Pit that can to be shared with the service provider. However, restricted PII, such as social security and credit card numbers, will not be shared with the service provider. The restricted Pit will only be reversed engineered and shared with authorized Pit entities.

The following are just a few benefits from using the present secure processing system according to embodiments of the present invention. The consumer and third party can greatly reduce the number of targets for hackers. The secure processing system token can remain just between authorized PII entities and the user. Huge amounts of money can be saved on replacement materials that contain these unique identifiers, i.e., re-issuing of new credit cards to consumers. And further, identity theft will decrease because the secure processing system tokens are only valid with strict criteria that determine who can use the secure processing system token, how long that secure processing system token is valid, and a token key that grants access to the secure processing system token.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secure processing system to protect personal identifiable information (PII) issued by an authorized PII entity to a user seeking to conduct a service with a service provider computing device of a service provider already registered with the secure processing system, comprising:
a server to receive the PII of the user, a token key, an authorized time frame identifier for a request of service, and service provider identifier from the user,
a processor to generate a secure system token based upon the received PII, token key, authorized time frame identifier and service provider identifier;
wherein:
the server sends the token to the user, and the server receiving the token, the token key and a request for service from the service provider computing device in response to a request for service which includes the token and the token key received from the service provider computing device based upon the request for service requested by the user from the service provider computing device,
the processor reverse engineering the PII based upon the received request for service from the service provider computing device, and
the server sending the reverse engineered PII to the authorized PII entity or back to the service provider computing device to complete the request for service.

2. The secure processing system according to claim 1, wherein the secure processing system never stores the PII.

3. The secure processing system according to claim 1, wherein the request for service further includes transaction details of the service and service provider credentials to confirm an identity of the service provider that was already registered with the secure processing system.

4. The secure processing system according claim 1, wherein the server sends the reverse engineered PII to the authorized PII entity to complete the request for service.

5. The secure processing system according claim 1, wherein the server sends the reverse engineered PII back to the service provider computing device to complete the request for service.

6. The secure processing system according to claim 1, wherein the service provider computing device never stores the PII.

7. The secure processing system according to claim 2, wherein the service provider computing device never stores the PII.

8. The secure processing system according to claim 1, wherein the service provider comprises a virtual machine which determines whether the processor is accessible to fulfill the request for the PII information form the service provider, and if the processor is not accessible, the virtual machine fulfills the request for PII information, and reverse engineers the PII based upon the received request for service requested by the user from the service provider.

9. The secure processing system according to claim 8, wherein the service provider computing device never stores the PII.

10. The secure processing system according to claim 1, wherein the secure processing system assigns a unique user identifier to each user, and multiple service providers are already registered with the secure processing system, wherein first and second ones of the multiple service providers with respective service provider computing devices share the unique user identifier of a common user, so that the PII of the common user is not provided between the first and second service provider computing devices, and when the PII of the common user is needed by the second service provider computing device, the first service provider computing device submits the user unique identifier to the secure processing system and the secure processing system makes the unique identifier available to the second service provider computing device, so that when the second service provider computing device contacts the secure processing system, the second service provider computing device has access to reverse engineer the PII of the common user.

11. The secure processing system according to claim 1, wherein the secure processing system enables the user to select from the PII, restricted PII that is only sharable with the authorized PII entity and non-restricted PII that is sharable with the service provider computing device.

12. The secure processing system according to claim 1, wherein:
the user submits the request for service, including the token, the token key and request for service details to the service provider computing device;
the service provider computing device appends service provider credentials to the request for service, and submits the request for service to the server;
the secure processing system further comprising a request verifier to verify if infomraiton in the request for service matches constraints specified by the user for use of the token, and validation is successful, the processor reverse engineers the token to generate the PII information; and
the server forwards the request for service modified to include the PII and the request for service details to the authorized PII entity.

13. The secure processing system according to claim 1, wherein:
the processor determines if the user wants to create a new token based upon an exising token which represents the PII already registered with the secure processing system or create a new token which represents new PII that has not been registered with the secure processing system;
if the processor determines that the user wants to create the new token based upon the exising token:
the processor contacts a database server of the secure processing system to look up the existing token, and the database server returns encrypted token data,
the processor contacts a data storage system of the secure processing system for proprietary data, and retrieves the proprietary data,
the processor reverse engineers the original PII using the encrypted token data and the proprietary data, and encodes the reversed engineered original PII to generate the new token; and
if the processor determines that the user wants to create the new token representing new PII:
the processor receives the new PII, encodes the new PII to generate the new token representing the new PII.

14. The secure processing system according to claim 12, wherein:
the processor determines if the user wants to create a new token based upon an exising token which represents the PII already registered with the secure processing system or create a new token which represents new PII that has not been registered with the secure processing system;
if the processor determines that the user wants to create the new token based upon the exising token:
the processor contacts a database server of the secure processing system to look up the existing token, and the database server returns encrypted token data,
the processor contacts a data storage system of the secure processing system for proprietary data, and retrieves the proprietary data,
the processor reverse engineers the original PII using the encrypted token data and the proprietary data, and encodes the reversed engineered original PII to generate the new token; and
if the processor determines that the user wants to create the new token representing new PII:
the processor receives the new PII, encodes the new PII to generate the new token representing the new PII.

15. The secure processing system according to claim 1, wherein the service provider identifier is based upon at least one of a particular geographical location automatically determined by the secure processing system, a radius of a distance set by the user, and a particular service provider identified by the user.

16. A secure processing system to protect personal identifiable information (PII) issued by an authorized PII entity to a user seeking to conduct a service with a service provider computing device of a service provider already registered with the secure processing system, service provider computing device comprising a virtual machine, the secure processing system comprising:
a server to receive the PII, a token key, an authorized time frame identifier for a request of service, and a service provider identifier from the user,
the virtual machine to generate a secure system token based upon the received PII, token key, authorized time frame identifier and service provider identifier;
wherein:
the server sends the token to the user, and the server receiving the token, the token key and a request for service from the service provider computing device in response to a request for service which includes the token and the token key received from the service provider computing device based upon the request for service requested by the user from the service provider computing device,
the virtual machine reverse engineering the PII of the user based upon the received request for service from the service provider computing device, and
the server sending the reverse engineered PII to the authorized PII entity to complete the request for service.

17. The secure processing system according to claim 16, wherein the secure processing system never stores the PII.

18. A method using a secure processing system to protect personal identifiable information (PII) issued by an authorized PII entity to a user seeking to conduct a service with a service provider computing device of a service provider already registered with the secure processing system, comprising:
receiving, through a server of the secure processing system, the PII of the user, a token key, an authorized time frame identifier for a request of service, and a service provider identifier from the user,
generating, using a processor of the secure processing system, a secure system token based upon the received PII, token key, authorized time frame identifier and service provider identifier;
sending, using the server, the token to the user, and receiving, using the server, the token, the token key and a request for service from the service provider computing device in response to a request for service which includes the token and the token key received from the service provider computing device based upon the request for service requested by the user from the service provider computing device,
reverse engineering, using the processor, the PII based upon the received request for service from the service provider computing device, and
sending, using the server, the reverse engineered PII to the authorized PII entity or back to the service provider computing device to complete the request for service.

19. The method according to claim 18, wherein the secure processing system never stores the PII.
